(19) United States
(12) Patent Application Publication
(10) Pub. No.: US 2006/0163873 A1
(43) Pub. Date: Jul. 27, 2006

(54) Connection assembly for pipelines

(75) Inventors: Dirk Langhuber, Paderborn (DE); Christian Ditter, Paderborn (DE); Christoph Lempa, Paderborn (DE)

Correspondence Address: Henry M. Feiereisen;Henry M. Feiereisen, LLC, Suite 4714, 350 Fifth Avenue, New York, NY, 10118, US

(73) Assignee: Benteler Automobiltechnik GmbH, Paderborn (DE)

(21) Appl. No.: 11/330,457

(22) Filed: Jan. 12, 2006

(30) Foreign Application Priority Data
Jan. 25, 2005 (DE) 10 2005 003 519.1

(51) Int. Cl. F16L 19/00; F16L 25/00

(52) U.S. Cl. 285/386; 285/354; 285/332; 285/332.1

(57) ABSTRACT

A connection assembly for attaching a pipeline to a distributor of a fuel or hydraulic system includes a threaded bushing placed adjacent to the distributor and having an internal bore in alignment with a connecting bore of the distributor, wherein the threaded bushing has a sealing seat. Disposed at one end of the pipeline is a sealing head which has a sealing surface and a pressure surface. The sealing surface and the pressure surface are each configured in the shape of a spherical segment defined by a radius of curvature having a center, wherein the center of the radius of curvature of the sealing surface is distanced from the center of the radius of curvature of the pressure surface. A union nut intended for connecting the pipeline to the threaded bushing forces the sealing surface of the sealing head in a pressure-tight manner against the sealing seat of the threaded bushing by at least indirectly acting upon the pressure surface.

### CROSS-REFERENCES TO RELATED APPLICATIONS

This application claims the priority of German Patent Application, Serial No. 10 2005 003 519.1, filed Jan. 25, 2005, pursuant to 35 U.S.C. 119(a)-(d), the content of which is incorporated herein by reference.

### BACKGROUND OF THE INVENTION

The present invention relates, in general, to a connection assembly for attachment of a pipeline to a fluid-operated consumer, e.g. a distributor of a fuel or hydraulic system.

Connection assemblies of a type involved here may be employed, for example, in fuel distributor systems of internal combustion engines. Fuel is hereby stored in the distributor and supplied via pipelines to various injectors of a cylinder bank. The term “distributor” is hereby to be understood to relate to a distributor block or any similarly configured distributor element as well as also to a tubular distributor.

U.S. Pat. No. 5,775,302 describes a connection assembly, whereby a plurality of threaded bushings are welded or soldered to one side of a distributor pipe. The bushings have internal bores for continuing branching bores in the wall of the distributor pipe. Disposed at the end of each pipeline is a sealing head which is pressed with its sealing surface against a sealing seat in the threaded bushing by means of a union nut screwed onto the bushing and thereby clamped in a pressure-tight manner. As the sealing head is drawn by the union nut against the sealing seat in the bushing, the geometry of sealing head and union nut results in an alignment of the sealing head and thus of the attached pipeline in such a way that the axis of the sealing head extends in parallel relationship to the axis of the threaded bushing. Manufacturing tolerances oftentimes cause however a deviation of these components from the ideal position so that the pipelines are forced into a position during threaded engagement via the union nut that results in tension in the pipeline and in the connection assembly overall. This tension may cause cracks when subjected to external mechanical stress such as vibrations or internal pressure pulsation, ultimately leading to a failure of the connection assembly.

It would therefore be desirable and advantageous to provide an improved connection assembly which obviates prior art shortcomings and which is compact and easy to manufacture while yet being reliable in operation.

### SUMMARY OF THE INVENTION

According to one aspect of the present invention, a connection assembly for attaching a pipeline to a distributor of a fuel or hydraulic system includes a threaded bushing placed adjacent to the distributor and having an internal bore in alignment with a bore of the distributor, with the threaded bushing having a sealing seat, a sealing head disposed at one end of the pipeline and having a sealing surface and a pressure surface, wherein the sealing surface and the pressure surface are each configured in the shape of a spherical segment defined by a radius of curvature having a center, wherein the center of the radius of curvature of the sealing surface is distanced from the center of the radius of curvature of the pressure surface, and a union nut intended for connecting the pipeline to the threaded bushing and forcing the sealing surface of the sealing head in a pressure-tight manner against the sealing seat of the threaded bushing by at least indirectly acting upon the pressure surface.

The present invention resolves prior art problems by configuring the sealing surface as well as the pressure surface of bulbed shape whereby the centers of the radii of curvature are disposed in spaced-apart relationship. As a result, any angular misalignment between the axis of the sealing head and the axis of the threaded bushing can be compensated, allowing the sealing head to align itself in relation to the sealing seat. Thus, the pipeline is not forced into position and thus tension in the pipeline can be eliminated or at least significantly reduced.

According to another feature of the present invention, the centers of the sealing surface and the pressure surface may be disposed in spaced-apart relationship on a common axis.

According to another feature of the present invention, the radius of curvature of the sealing surface may be smaller than the radius of curvature of the pressure surface.

According to another feature of the present invention, the sealing head may have an annular rounded collar defining a transition between the pressure surface and the sealing surface

According to another feature of the present invention, the union nut may be formed with an inwardly slanted wrap-around thrust shoulder for bearing against the pressure surface of the sealing head. The thrust shoulder is slanted in relation to the length axis of the union nut and has a conical slanted surface. To assist the angular compensation, the thrust shoulder may be configured in the form of a spherical segment that conforms to a contour of the pressure surface of the sealing head. Thus, the thrust shoulder of the union nut is also of bulbed shape with a congruent radius of curvature.

Depending on the configuration of the connection assembly in dependence on the demanded flow rate or flow capacity of the fuel or hydraulic system, the installation state, and the used materials, the radius of curvature of the sealing surface may range from 2 mm to 5 mm, whereas the radius of curvature of the pressure surface may range from 5 mm to 15 mm. Suitably, a ratio of the radius of curvature of the sealing surface to the radius of curvature of the pressure surface may range between 1:2 to 1:7.5.

According to another feature of the present invention, the internal bore of the threaded bushing may have a conical length portion to define the sealing seat, with the length portion having a cone angle of 25° to 35°. Currently preferred is a cone angle of 30°.

According to another feature of the present invention, the sealing head may be part of an end piece joined to the pipeline. Suitably, the end of the pipeline may hereby be joined in an adapter portion of the end piece.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a vertical cross section of one end of a pipeline with terminal sealing head and union nut forming part of a connection assembly according to the present invention; and

FIG. 2 is a vertical cross section of the connection assembly according to the present invention for securing the pipeline to a distributor.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

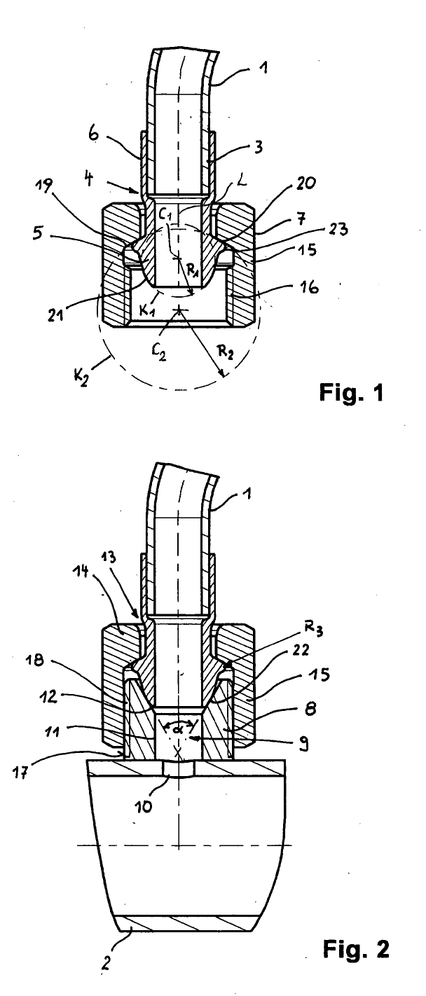

Turning now to the drawing, and in particular to FIG. 1, there is shown a vertical cross section of one end 3 of a pipeline 1 for attachment to a distributor 2 (FIG. 2) of a fluid-operated system such as a fuel or hydraulic line system. Attached to the end 3 of the pipeline 2 is a metallic end piece, generally designated by reference numeral 4 and forming part of a connection assembly which is shown in more detail in FIG. 2. The end piece 4 includes a leading sealing head 5 and a trailing adapter portion 6. The end 3 of the pipeline 2 is inserted in the adapter portion 6 and joined thereto by soldering for example.

FIG. 2 shows in more detail the connection assembly for securing the pipeline 1 to the distributor 2. The distributor 2 is hereby configured in the form of a pipe or tubular body and may involve a distributor pipe of an injection system of an internal combustion engine. Fuel is hereby stored in the distributor 2 and fed to the injectors of a cylinder bank via a suitable number of pipelines 1 (only one pipeline 1 is shown in the drawing for sake of simplicity). It will be appreciated by persons skilled in the art that the number of pipelines 1 connected to the distributor corresponds to the number of cylinders.

The attachment of the pipeline 1 to the distributor 2 is realized by a metallic union nut 7 and a metallic threaded bushing 8. The threaded bushing 8 is attached to one side of the distributor 2 and secured by a suitable joining process such as brazing or welding. The threaded bushing 8 is formed with an internal bore 9 extending end-to-end and continuing a connecting bore 10 in the distributor 2. The internal bore 9 includes a cylindrical length portion 11 and a conically widening length portion 12. The length portion 11 has a diameter which is sized greater than the diameter of the connecting bore 10 in the distributor 2. This allows for tolerance, when securing the threaded bushing 8 to the distributor 2 so that a reliable fluid communication is ensured between the distributor 2 and the threaded bushing 8 even in the absence of a precise alignment.

The union nut 7 has a distributor-distal end 14 formed with an opening 13 for receiving the pipeline 1 and can rest against the sealing head 5. Attachment of the pipeline 1 to the distributor 2 is implemented by threadably engaging the union nut 7 onto the threaded bushing 8. The union nut 7 is hereby formed with a sleeve portion 15 having an internal thread 16 for threaded engagement onto a threaded portion 18 about the outer circumference 17 of the threaded bushing 8. Formed on the inside of the distributor-distal end 14 of the union nut 7 is an inclined thrust shoulder 19 which is urged against a pressure surface 20 of the sealing head 5, when the union nut 7 is secured. The thrust shoulder 19 is configured to conically widen from the opening 13 in the distributor-distal end 14 in the direction of the sleeve portion 15. When the union nut 7 is screwed on and applies a force to urge the thrust shoulder 19 against the pressure surface 20, the sealing head 5 is pressed with its leading sealing surface 21 against the length portion 12 of the internal bore 9 of the threaded bushing 8.

The conical surface of the length portion 12 forms a sealing seat 22 against which the sealing head 5 is forced with its sealing surface 21 in a pressure-tight manner.

The leading sealing surface 21 as well as the side of the pressure surface 20, facing away from the sealing surface 21 in the direction of the pipeline 1, are configured in the shape of spherical segment. This bulbed contour of the sealing surface 21 and the pressure surface 20 of the sealing head 5 is illustrated in more detail in FIG. 1 by way of the depicted circles K₁ and K₂. The circle K₁ of the sealing surface 21 has a center C₁ and is defined by a radius of curvature R₁, and the circle K₂ of the pressure surface 20 has a center C₂ and is defined by a radius of curvature R₂. The centers C₁ and C₂ are hereby positioned at a distance to one another on the length axis L of the sealing head 5. A transition between the pressure surface 20 and the sealing surface 21 is formed by a rounded annular collar 23 having a radius R₃.

The spherical-segment-shaped contour of the sealing surface 21 and the pressure surface 20 allows an angle compensation between the axis L of the sealing head 5 and the axis of the threaded bushing 8. Thus, as the sealing head 5 is clamped against the sealing seat 22 of the threaded bushing 8, as the union nut 7 is tightened, any angular misalignment is spontaneously compensated so that a forced disposition of the pipeline 1 and thus tension in the pipeline 1 is prevented or at least significantly reduced. As a result, the reliability of the connection assembly according to the present invention is appreciably enhanced. Damage to components of the connection assembly, in particular cracks due to mechanical changing stress during operation, is effectively prevented.

In the non-limiting example, shown in the drawing, the radius of curvature R₁ of the sealing surface 21 is 3.5 mm, whereas the radius of curvature R₂ of the pressure surface 18 is 8.5 mm. Thus, the ratio of radius of curvature R₁ of the sealing surface 21 and radius of curvature R₂ of the pressure surface 18 is 1:2.43. The sealing seat 22 and thus the conical length portion 12 of the internal bore 9 has a cone angle α of 30°. The radius R₃ of the annular collar 23 of the sealing head 5 is 0.7 mm.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A connection assembly for attaching a pipeline to a distributor of a fuel or hydraulic system, comprising:
a threaded bushing placed adjacent to the distributor and having an internal bore in alignment with a connecting bore of the distributor, said threaded bushing having a sealing seat;
a sealing head disposed at one end of the pipeline and having a sealing surface and a pressure surface, wherein the sealing surface and the pressure surface are each configured in the shape of a spherical segment defined by a radius of curvature having a center, wherein the center of the radius of curvature of the sealing surface is distanced from the center of the radius of curvature of the pressure surface; and
a union nut intended for connecting the pipeline to the threaded bushing and forcing the sealing surface of the sealing head in a pressure-tight manner against the sealing seat of the threaded bushing by at least indirectly acting upon the pressure surface.

2. The connection assembly of claim 1, wherein the centers of the sealing surface and the pressure surface are disposed in spaced-apart relationship on a common axis.

3. The connection assembly of claim 1, wherein the radius of curvature of the sealing surface is smaller than the radius of curvature of the pressure surface.

4. The connection assembly of claim 1, wherein the sealing head has an annular rounded collar defining a transition between the pressure surface and the sealing surface.

5. The connection assembly of claim 1, wherein the union nut is formed with an inwardly slanted thrust shoulder bearing against the pressure surface of the sealing head.

6. The connection assembly of claim 5, wherein the thrust shoulder is configured in the form of a spherical segment conforming to a contour of the pressure surface of the sealing head.

7. The connection assembly of claim 1, wherein the radius of curvature of the sealing surface is 2 mm to 5 mm, and the radius of curvature of the pressure surface is 5 mm to 15 mm.

8. The connection assembly of claim 1, wherein a ratio of the radius of curvature of the sealing surface to the radius of curvature of the pressure surface ranges between 1:2 to 1:7.5.

9. The connection assembly of claim 1, wherein the internal bore of the threaded bushing has a conical length portion to define the sealing seat, said length portion having a cone angle of 25° to 35°.

10. The connection assembly of claim 9, wherein the cone angle is 30°.

11. The connection assembly of claim 1, wherein the sealing head is part of an end piece joined to the pipeline.

12. The connection assembly of claim 11, wherein the end of the pipeline is joined in an adapter portion of the end piece.

13. The connection assembly of claim 1, wherein the internal bore has a diameter which is greater than a diameter of the connecting bore in the distributor.
